(19) United States
(12) Patent Application Publication
(10) Pub. No.: US 2020/0173966 A1
(43) Pub. Date: Jun. 4, 2020

(54) DEVICES AND METHODS FOR ENRICHING PEPTIDES DURING BIOANALYTICAL SAMPLE PREPARATION

(71) Applicant: NANOMEDICAL SYSTEMS, INC., Austin, TX (US)

(72) Inventors: Randy GOODALL, Austin, TX (US); Sharath HOSALI, Austin, TX (US); Stephanie PASAS-FARMER, Austin, TX (US)

(73) Assignee: NANOMEDICAL SYSTEMS, INC., Austin, TX (US)

(21) Appl. No.: 16/615,417

(22) PCT Filed: May 31, 2018
(86) PCT No.: PCT/US2018/035379

§ 371 Date: Nov. 21, 2019

Related U.S. Application Data
(60) Provisional application No. 62/513,712, filed on Jun. 1, 2017.

(51) Int. Cl. G01N 30/08; G01N 30/72; G01N 30/52

(52) U.S. Cl. CPC G01N 30/08; G01N 30/52; G01N 30/7233

(57) ABSTRACT

Methods and devices for enriching a molecular component within a sample. Certain embodiments include a rigid body, a malleable adhesive, and a nanoporous layer coupled to the rigid planar substrate.

### CROSS-REFERENCE TO RELATED APPLICATIONS

This application claims priority to U.S. Provisional Patent Application Ser. No. 62/513,712 filed Jun. 1, 2017, the contents of which are incorporated herein by reference.

### BACKGROUND INFORMATION

Bioanalytical identification and quantification of specific molecular components in body fluids is a critical enabler of clinical translation of both drugs and diagnostics. Two independent trends in clinical treatment have brought challenges in assay development and deployment. In drug discovery, small molecule drugs have given ground to biologic drugs, with a natural first step in moving up the molecular weight scale opening the door to peptide therapeutics. In diagnostics, circulating biological molecules are now seen as communication vectors—“biomarkers”, signaling the presence of disease states even at their earliest onset. The regime of circulating biomolecules in the molecular weight range 1 kDa-10 kDa, which generally includes peptides but also includes nucleotides and small proteins, represents a rich regime in which biomarkers are being sought and found (see FIG. 1). Further merging these trends in the peptide size regime is the move to personalized medicine where biomarkers are used as inclusion/exclusion criteria for clinical trials, predictive tools for determining response to a drug, “companion diagnostics” for new drug therapies, and other uses.

A translational challenge for the development of both drugs and diagnostics is the corresponding development and deployment of assays for identification and quantification of biomolecules in the peptide regime. The gold standard for biomolecule analysis has traditionally been ELISA. ELISA assays can be specific and sensitive; however, they can be expensive to run due to reagent costs and typically are not able to distinguish isotopes or monitor catabolism or post-translational changes of peptides and proteins in vivo. Furthermore, in drug discovery, where speed matters, for a new target biomolecule it may take months to culture the necessary antibodies for an ELISA assay.

Liquid Chromatography Mass Spectrometry (LC-MS) has emerged as a powerful technique in modern assays. LC-MS instruments can separate and quantify biomolecules based on affinity properties (e.g., hydro-philicity/-phobicity) as well as precision measurement of molecular weight.

Exponential improvements in computational technology have advanced the technical design control and real-time data analysis capability of the mass spectrum instruments, but these finely tuned instruments need samples that are prepared specifically to meet their “sweet spot” behaviors. In many cases, this means removing uninteresting or interfering components from samples before introducing them into the mass spectrometer. For the detection of biomolecules in the peptide regime, techniques exist to perform this task with wide tradeoffs in cost, performance, and complexity.

To deliver high-quality quantification results, an LC-MS instrument requires sample preparation techniques specifically suited to the manipulation of peptides and proteins. Solid-Phase Extraction (SPE) was originally well characterized for small (non-biologic) molecules as a sample preparation technique for LC-MS; however, the transition from small molecule to biologic molecule analysis has had mixed results. For example, SPE assays are not easily developed for macromolecules which can stick to the solid phase sorbent rather than elute as a bolus during the elution step of the protocol. To overcome these SPE issues, bioanalytical scientists must in some cases add ELISA into these protocols to capture the large molecules in the biological sample. These combination assays can be extremely complex, requiring long incubations times, extensive wash and digestion steps, and sample preparation work flows at least 4-6 hours post incubation, resulting in high total cost per sample. Therefore, there is a great industry need for a simple, straightforward, and cost-effective sample preparation technique for peptide and protein analysis by LC-MS.

Another widely used mass spectrometry technique and instrument type is matrix assisted laser desorption/ionization (MALDI) time of flight (TOF). While MALDI-TOF MS is known not to have the equivalent quantification capability of LC-MS, its wide molecular weight capture range and simplicity of use have made it a common tool for detecting biological molecules such as peptides and proteins, whether circulating dosed drugs or circulating disease biomarkers. Because larger molecules in a biological sample can interfere with the MALDI ionization process, there is a great industry need for a simple, straightforward and cost-effective sample preparation technique to isolate and enrich peptides while excluding larger molecule.

The new and novel industry innovation needed, as noted above, i.e., enriching the peptide portion of a biological sample provides improvements in key technical and commercial performance parameters, including without limitation:
Minimal preparation required for the device itself;
Less than 1-hour sample processing time for many samples in parallel;
No proprietary laboratory equipment and reagents;
Inherent performance variability at least as low as the subsequent mass spectroscopy processes;
High recovery of target analytes.

Certain nanoscale structured materials have been demonstrated for the fractionation of biological samples, e.g., by using a nanoporous thin film layer in biological sample preparation that specifically enriches the peptide regime. The primary functional operation of a nanoporous surface in the device of the present invention and using the methods of the present invention is the preferential inclusion of peptide molecules, e.g., in the molecular weight range 1 kDa-10 kDa, and the preferential exclusion of larger molecules, e.g., proteins. This happens because the surface of a nanoporous layer primarily comprises pore openings that lead to extended pores of generally uniform diameter, traveling below the surface of the layer for many nanometers. The effective surface area for capture of molecules includes not only the nominal planar surface area of a portion of the nanoporous layer, but also the surface area of the pores under that region, but only for molecules with nominal diameters such that they can enter the pores to access the additional surface area. Because the additional sub-surface area is many tens of times larger than the nominal planar surface area (where some larger molecules might still be captured), there is a significant enrichment of smaller molecules to large molecules when the surface is chemically treated to release all bound molecules. This “size exclusion” feature is a powerful tool for isolating peptide from larger molecules in a biological sample. Exemplary embodiments of the devices and methods according to the present invention comprise this and other capabilities.

### SUMMARY

Exemplary embodiments of the present invention include methods and devices for enriching a molecular component within a sample. Certain embodiments include a rigid body, a malleable adhesive, and a nanoporous layer coupled to the rigid planar substrate.

Certain embodiments include a device for enriching a molecular component within a sample, where the device comprises: a rigid planar substrate comprising a first side and a second side; a malleable adhesive; a nanoporous layer coupled to the first side of the rigid planar substrate, wherein the nanoporous layer is disposed between the rigid planar substrate and the malleable adhesive; and a plurality of wells coupled to the nanoporous layer, wherein the malleable adhesive seals the plurality of wells to the nanoporous layer.

Particular embodiments include a device for enriching a molecular component within a sample, where the device comprises: a plurality of rigid planar substrates, each comprising a first side and a second side; a malleable adhesive; a plurality of nanoporous layers coupled to the first side of each rigid planar substrate, wherein the nanoporous layers are disposed without overlap between the rigid planar substrates and the malleable adhesive; and a plurality of wells coupled to the nanoporous layers, wherein the malleable adhesive seals each of the plurality of wells to only one of the nanoporous layers. In some embodiments, each of the plurality of nanoporous layers differs in at least one parameter. In specific embodiments, the at least one parameter is selected from the group consisting of thickness, porosity, pore size, pore wall material, surface functionalization, and surface interaction.

In certain embodiments, the malleable adhesive layer comprises a plurality of perforations. In particular embodiments, the plurality of perforations correspond in size and shape to the plurality of wells. In particular embodiments, the plurality of perforations comprises circular perforations and the plurality of wells comprise circular wells. In some embodiments, the plurality of perforations comprises circular perforations that are larger in diameter than the circular wells. In specific embodiments, the wherein the plurality of perforations comprises circular perforations that are larger in diameter than the circular wells by 50-150 micrometers.

In certain embodiments, the plurality of perforations comprises circular perforations that are larger in diameter than the circular wells by 100 micrometers. In particular embodiments, the plurality of wells comprise walls extending through a rigid body. In some embodiments, the nanoporous layer forms a bottom layer of the plurality of wells. In specific embodiments, a surface of the first side of the one or more planar substrates comprises a feature which increases a surface area of a nanoporous layer coupled thereto. In certain embodiments, the feature is selected from the group consisting of micrometer-scale rulings, roughening, chemical or mechanical texturing, topography patterned into the surface by etching, and additive microfibers. In particular embodiments, the nanoporous layer comprises a thickness that does not vary more than 10 percent across the nanoporous layer. In some embodiments, the nanoporous layer comprises a thickness that does not vary more than 5 percent across the nanoporous layer. In specific embodiments, the nanoporous layer comprises a porosity that does not vary more than 10 percent across the nanoporous layer. In certain embodiments, the nanoporous layer comprises a porosity that does not vary more than 5 percent across the nanoporous layer. In particular embodiments, the average pore diameter is from 3 nm to 10 nm, or more particularly between 3 and 4 nm, or between 4 and 5 nm, or between 5 and 6 nm, or between 6 and 7 nm, or between 7 and 8 nm, or between 8 and 9 nm, or between 9 and 10 nm. In other embodiments the average pore diameter is more than 10 nm.

In certain embodiments, the malleable adhesive is disposed between the plurality of wells, which is in the form of single piece of material, e.g., plastic, in which the wells are a fixed array of through-holes such that the bottoms of the wells form a fixed array of openings on the planar bottom of the piece, and the nanoporous layer formed on the rigid planar substrate. Further in these embodiments, the malleable adhesive may be in the form of a two-sided adhesive sheet, wherein, as known in the art, a non-sticking protective film is disposed over each of the two sides of the adhesive sheet, and the adhesive sheet and the protective films are perforated in a pattern matching the locations of the fixed array of holes on the piece. Such an embodiment may be assembled by first removing one protective film from the adhesive sheet, aligning the fixed array of holes in the adhesive sheet to the fixed array of holes in the piece, and applying pressure to bond the adhesive sheet to the piece. The pressure can be applied using a planar pressure plate comprising a pattern of raised features which matches the locations of the spaces between the openings on the planar piece. The raised features may be a grid of raised lines, each narrower in width that the spaces between the openings, such that the areas bounded by the lines of the grid are aligned to the perforations of the adhesive sheet and the openings of the piece. In this configuration, pressure is first applied to the adhesive sheet by the raised features, being between the openings, so that the adhesive will bond there first, and, as further pressure is applied, remaining areas of the adhesive sheet further from the grid lines will successively bond, causing air in the region of bonding to be successively expelled, thereby preventing trapping of air under the adhesive sheet in the form of bubbles. The piece may then rest for 1, 2, 3, 4, or more hours, so that the impression formed in the malleable adhesive by the raised features can visco-elastically relax, bringing the unbonded surface of the attached adhesive sheet into a planar state. An elevated temperature can be applied to accelerate the relaxation. The remaining protective film is removed from the attached adhesive sheet, and the rigid planar substrate is aligned with the piece as appropriate and placed onto the adhesive sheet such that the nanoporous layer is bonded to the adhesive sheet. Pressure is applied with a planar pressure plate. Because the adhesive sheet has relaxed into a planar state, no air is trapped as the rigid planar substrate is laid upon the adhesive sheet, so no bubbles are formed beneath.

In the foregoing embodiment, the final assembled device exposes the nanoporous material within each of the wells to the ambient environment, which can include normal gaseous components of air (e.g., nitrogen and oxygen) as well as water vapor. Because water vapor can enter the pores, attach to the subsurface walls of the pores, and lower the effective porosity of the nanoporous layer, it is desirable to package the device in a manner that prevents this occurrence. Conventional means of packaging within a dry-nitrogen back-filled bag, which is impervious to water vapor, e.g., aluminized biaxial-oriented polyethylene terephthalate (“Mylar”), do not provide sufficient prevention of water vapor collecting within the pores of the nanoporous layer, when the layer is deep within another structure. A novel method of providing such prevention involves the use of a thin (e.g., 1, 2, 3, 4, 5, 6 mm thick), hollow, planar paddle with lateral dimensions approximately equal to the lateral dimensions of the finished device that comprises an extended hollow tubular handle ending with an inlet that allows dry-nitrogen to be supplied to the hollow paddle, which itself has perforations allowing dry-nitrogen to be released. The assembled device may be pushed into a bag using the paddle, which has downward projecting ledge that engages the trailing edge of the device for this pushing purpose. Once fully within the bag, the dry-nitrogen is turned on and flows through the handle to the paddle. To ensure that the nanoporous layer pores are thoroughly purged of water vapor, the perforations on the downward face of the paddle are arrange in a pattern matching the pattern of the wells in the device, so that each well is thoroughly filled with dry-nitrogen. This high-concentration of dry-nitrogen within each well leads to the immediate out-diffusion of water vapor from the pores within the wells, with such water vapor being unable to redeposit on any part of the device due to the general flow of dry-nitrogen from the paddle maintaining a gas flow out of the bag. As the wand is withdrawn, the bag is immediately heat sealed, as known in the art, and the nitrogen flow stopped. The device will have a stable porosity for 6, 12, 18, or 24 months.

Certain embodiments include a method of enriching a target analyte within a sample, where the method comprises: obtaining a device according to the present disclosure (including for example, a device according to claim 1); mixing the sample with one or more reagents to form a sample reagent mixture; introducing the sample reagent mixture into one or more wells of the plurality of wells, wherein the target analyte is retained by the nanoporous layer at the bottom of each of the one or more wells and wherein a supernatant remains in each of the one or more wells; removing the supernatant from each of the one or more wells; adding a washer buffer to each of the one or more wells; removing the washer buffer from each of the one or more wells; adding an elution buffer to each of the one or more wells to release the target analyte from the nanoporous layer; and removing the elution buffer and the target analyte from each of the one or more wells.

In particular embodiments, the one or more reagents comprise a compound configured to adjust the pH of the sample reagent mixture to enhance an affinity of the target analyte to be retained by the nanoporous layer. In some embodiments, the elution buffer comprises a compound configured to adjust the pH of the sample reagent mixture to reduce an affinity of the target analyte to be retained by the nanoporous layer.

Certain embodiments include a method of enriching a target analyte within a sample, where the method comprises: obtaining a device according to the present disclosure (including for example, a device according to claim 2); mixing the sample with one or more reagents to form a sample reagent mixture; introducing the sample reagent mixture into one or more wells of the plurality of wells, wherein the target analyte is retained by the nanoporous layer at the bottom of each of the one or more wells and wherein a supernatant remains in each of the one or more wells; removing the supernatant from each of the one or more wells; adding a washer buffer to each of the one or more wells; removing the washer buffer to each of the one or more wells; adding an elution buffer to each of the one or more wells to release the target analyte from the nanoporous layer; and removing the elution buffer and the target analyte from each of the one or more wells.

In particular embodiments, the one or more reagents comprise a compound configured to adjust the pH of the sample reagent mixture to enhance an affinity of the target analyte to be retained by the nanoporous layer. In some embodiments, the elution buffer comprises a compound configured to adjust the pH of the sample reagent mixture to reduce an affinity of the target analyte to be retained by the nanoporous layer.

Certain embodiments include a method of enriching a target analyte within a sample, where the method comprises: (1) obtaining a device comprising at least one rigid planar substrate comprising: a first side and a second side; a malleable adhesive; a plurality of nanoporous layers coupled to the first side of the at least one rigid planar substrate, wherein the nanoporous layers are disposed without overlap between the at least one rigid planar substrate and the malleable adhesive; and a plurality of wells coupled to the nanoporous layers, wherein the malleable adhesive seals each of the plurality of wells to only one of the nanoporous layers; (2) mixing portions of the sample with each of a plurality of reagents to form a plurality of sample reagent mixtures; (3) introducing the plurality of sample reagent mixtures into the plurality of wells, where: only one sample reagent mixture of the plurality of sample reagent mixtures is added to each well of the plurality of wells; the target analyte is retained by the nanoporous layer at the bottom of each well of the plurality of wells; and a supernatant remains in each well of the plurality of wells; (4) removing the supernatant from each well of the plurality of wells; (5) adding a washer buffer to each well of the plurality of wells; (5) removing the washer buffer from each well of the plurality of wells; (6) adding an elution buffer to the plurality of wells to release the target analyte from the plurality of nanoporous layers; and (7) removing the elution buffer and the target analyte from each well of the plurality of wells.

Particular embodiments further comprise comparing an amount of target analyte removed from each well of the plurality of wells. Some embodiments further comprise determining a maximum amount of the amount of target analyte removed from each well of the plurality of wells. Specific embodiments further comprise determining an optimal well from which the maximum amount of target analyte was removed. Certain embodiments further comprise: documenting the nanoporous layer to which the optimal well is sealed; and documenting the reagent that was mixed in the sample reagent mixture that was introduced in the optimal well. In particular embodiments, each of the plurality of nanoporous layers differs in at least one parameter. In some embodiments, at least two of the plurality of nanoporous layers differ in thickness. In specific embodiments, at least two of the plurality of nanoporous layers differ in porosity.

In certain embodiments, at least two of the plurality of nanoporous layers differ in pore size. In particular embodiments, at least two of the plurality of nanoporous layers differ in pore wall material. In specific embodiments, at least two of the plurality of nanoporous layers differ in surface functionalization. In some embodiments, at least two of the plurality of nanoporous layers differ in surface interaction.

### BRIEF DESCRIPTION OF FIGURES

The following drawings form part of the present specification and are included to further demonstrate certain aspects of the present disclosure. The invention may be better understood by reference to one of these drawings in combination with the detailed description of specific embodiments presented herein.

FIG. 1. Range of molecular sizes showing relevant peptide range.

FIG. 2. Exploded view of present invention.

FIG. 3. Illustration of component interfaces of present invention—macro scale.

FIG. 4. Illustration of component interfaces of present invention—micro scale.

FIG. 5. Illustration of component interfaces of present invention—nano scale.

FIG. 6A. Demonstration of malleable adhesive blocking diffusive movement in and within nanoporous layer.

FIG. 6B. How multiple planar substrates can be seamed to provide bottoms for distinct subsets of wells.

FIG. 7. A conventional fully plastic 96-well plate (single molded piece with plastic bottoms). The dimensions are about 5″×3.4″×0.5″ high.

FIG. 8. A conventional 96-well plate with a plastic molded body and a simple glass bottom adhered to it. This is used when light must be available in the well for observation or various analytical instruments to detect biological phenomena. The dimensions are about 5″×3.4″×0.5″ high.

FIG. 9. A non-standard 96-well plate with a plastic molded body in which each open-bottom well is actually a small liquid chromatographic column for filtering a sample, with the effluent collecting in a tray beneath the well plate. This is called a solid phase extraction (SPE) plate. While different in biochemical structure and action, this plate can be used to perform the action of enriching a molecular component of a biological sample. The dimensions are about 5″×3.4″×1.5″ high.

FIG. 10. A flexible silicone sheet is laid (without adhesive) on a substrate (in this case a piece of silicon wafer) that has a nanoporous layer on it. The holes in the silicone become small wells for holding and processing a sample, however, (1) the wells do not form a rigid body protecting the substrate from stresses and (2) the silicone sheet can distort under small side forces to detach from the substrate, thereby losing the integrity of the wells and allowing well-to-well leaking and loss of sample. The dimensions are about 3″×1″×⅛″ high.

FIG. 11. Response curves for Insulin B Chain when sample prepared used the device and methods of the present invention.

FIG. 12. Table for recommended pH for peptide isoelectric point ranges.

FIG. 13. Results of electrostatic capture test.

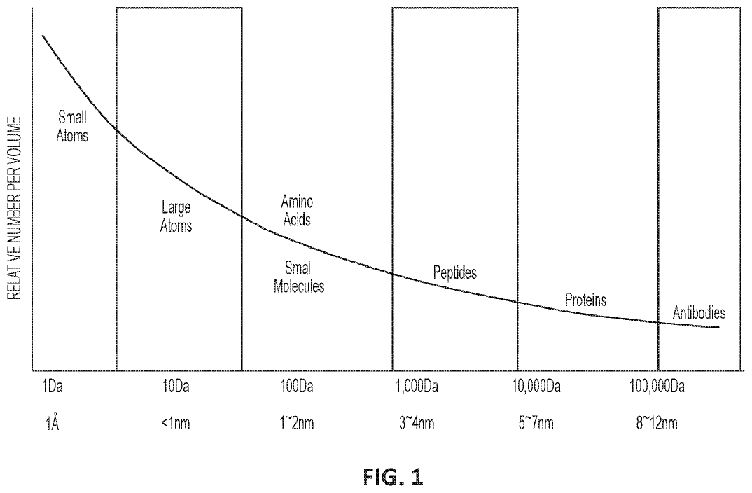

### DETAILED DESCRIPTION OF EMBODIMENTS

Embodiments of the present invention include a device of novel design that embodies nanoporous material in a configuration that meets the technical and commercial performance requirements noted above.

Embodiments of the present invention comprise an innovative combination of features and attributes, including, without limitation the following aspects. Certain embodiments include two or more identically shaped wells for containing fluidic biological samples up to 300 μL each. In particular embodiments, the fluidic biological samples have static (non-flow-through) exposure to the nanoporous material. In some embodiments, the wells are rigidly fixed in location and orientation relative to each other. In specific embodiments, each well has a constant area of exposure to the nanoporous material. In certain embodiments, the nanoporous material in all wells or a defined subset of wells is identical in composition and physical attributes. In particular embodiments, the device body provides rigid protection for the nanoporous material, which comprises a thin film layer on a fragile substrate or set of substrates. In some embodiments, the device body provides for adhesion of the nanoporous material such that each well is fluidically isolated from neighboring wells, including the fluidic biological sample diffusing laterally within the nanoporous layer to reach an adjacent well.

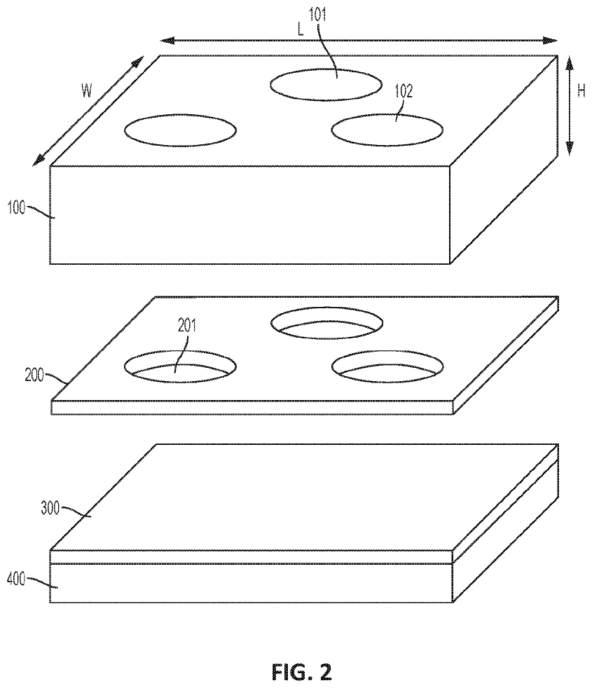

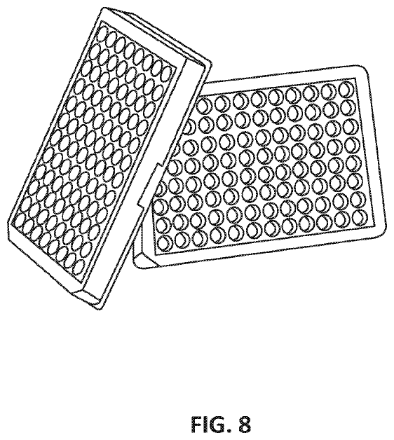

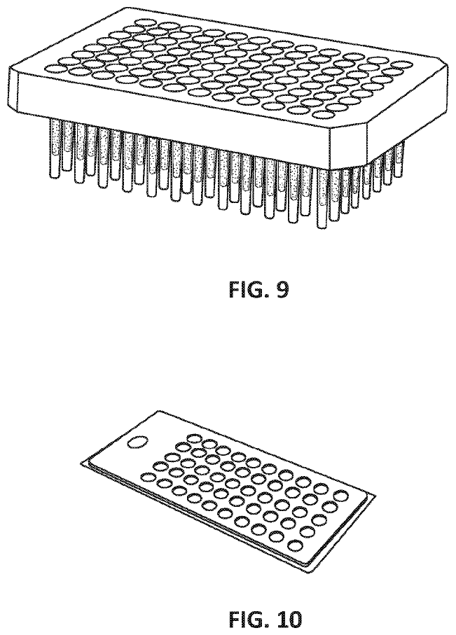

Embodiments of the present invention comprise a device with several components as described below and illustrated in FIGS. 2 through 10. These combine into the novel device with the features/attributes noted above that meets the requirements noted above.

Referring to FIG. 2, an exploded view of a device 10 shows a rigid body 100 containing wells 101 defined by walls 102, a malleable adhesive 200 with perforations 201, and a planar substrate 400 on which a nanoporous layer 300 has been coupled.

In the embodiment shown, rigid body 100 provides the overall physical structure and dimensions of the device. It also provides the layout and dimensionality of the wells 101 that will hold the fluidic biological samples. The rigid body can be made of any stable, rigid substance and by a variety of fabrication means, including without limitation, injection molding, blow molding, 3-D printing, or machining. Suitable materials include polymers such as polystyrene, polypropylene, PEEK, PVC, polycarbonate, cyclic olefin copolymer, glass, chemically inert metals or other substances are also suitable materials. The material of the rigid body that makes up the inner walls 102 of the individual wells may be treated with heat, plasma, chemical agents, coatings, and other means known in the art to make the surface receptive to or unreceptive to binding of biological molecules.

Rigid body 100 has a length, L, and a width, W, and a height, H, with both the length and width being larger than the height. The rigid body comprises the well walls 102 of the device. In certain embodiments all the wells 101 are the same dimensions, and each well has an opening on the top surface of the rigid body and on the bottom of the rigid body, with a major axis defined by the geometric center points of the top and bottom openings, with the major axis of all wells being parallel and collectively perpendicular to the length-width plane of the rigid body. Without limitation, the shape of the top openings and the bottom openings of the wells can be circular or square or another shape, and are not required to be the same. The walls of the wells may be of any particular cross-section between the top opening and the bottom opening to facilitate volumetric manipulation of the fluidic sample to, for example, maximize contact area with the nanoporous layer or reduce the effective depth of the fluidic sample in the well for a given volume of fluid. In certain embodiments the wall cross section in a plane that contains the major axis of a well of a well comprises straight lines from the top to bottom of the rigid body, and the angle of the walls of the wells from the front or back surface planes of the right body are between 85° and 95°.

In certain embodiments, the rigid body can be injection molded polymer. This can help to ensure a maximally planar bottom surface to which the planar substrate is coupled using a malleable adhesive. The portion of the rigid body between the wells can have any configuration which maintains stiffness of the rigid body and that does not allow the deflections of the rigid body by more than 1 millimeter from planarity, which could crack or otherwise damage the adhering planar substrate or cause the malleable adhesive to fail to adhere. In certain embodiments the material configuration of the bottom side of the rigid body should be such that there is about 2 millimeters of continuous annular planar material around each bottom well opening to which the malleable adhesive can adhere. The remaining portions of the rigid body may be formed according to means known in the art to reduce material mass requirements, add stiffness, or meet other exogenous dimensional requirements, e.g., compliance with automated handling standards.

In certain embodiments, the substrate may be transparent or translucent to allow visualization from the back side of the substrate to allow other detection methods such as optical or electrical detection alone or in combination with LC-MS, MALDI-TOF, etc. as explained in more detail below.

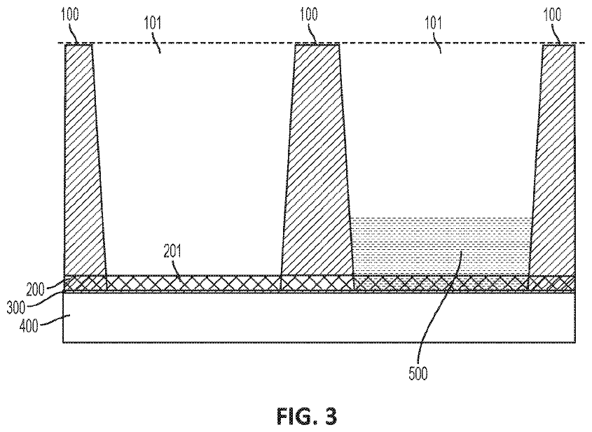

In the embodiment shown, malleable adhesive 200 is disposed between the rigid body 100 and planar substrate 400 with nanoporous layer 300 on its surface. The pattern of adhesion for malleable adhesive 200 comprises perforations 201 matching the layout and nominal dimensions of the well pattern on the bottom of rigid body 100. In certain embodiments, the malleable adhesive can be a preformed sheet of transfer adhesive, e.g., 3M® 4905. In particular embodiments, the malleable adhesive can be a preformed polymeric sheet with adhesive pre-applied to its surfaces, e.g., 3M® 1567 or 3M® 9495LE. In some embodiments, the malleable adhesive can be an applied glue layer, e.g., applied in a bead and set thermally or by UV application. In particular embodiments, the malleable adhesive can be a thin liquefied layer of the rigid body material, e.g., if the rigid body comprises a polymer, it may be temporarily melted such that upon contact with the planar substrate it fuses and hardens to adhere to the planar substrate. Now referring to FIG. 3, the innovative use of malleable adhesive 200 simultaneously performs several important functions. First, malleable adhesive 200 attaches planar substrate 400 to rigid body 100 such that a bottom 103 of a well, formed by such attachment, solely comprises nanoporous layer 300 on the surface of planar substrate 400. This helps to ensure that a fluidic biological sample 500 engages nanoporous layer 300.

Second, malleable adhesive 200 via perforations 201 defines the “active area” of each well, since the portion of nanoporous layer 300 on the surface of planar substrate 400 that can be accessed by fluidic biological sample 500 is only that area within the boundary of the perforation 201 in malleable adhesive 200. In certain embodiments, the hole pattern of malleable adhesive 200 is about 100 micrometers larger than the actual bottom well opening of rigid body 100. This helps to ensure that small variabilities in the relative position of rigid body 100 and malleable adhesive 200 (e.g., shifts of less than about 100 micrometers) do not change the active area of the well or increase the exposure area of malleable adhesive 200 to the fluidic biological sample 500 in the well, both being important performance attributes of the device.

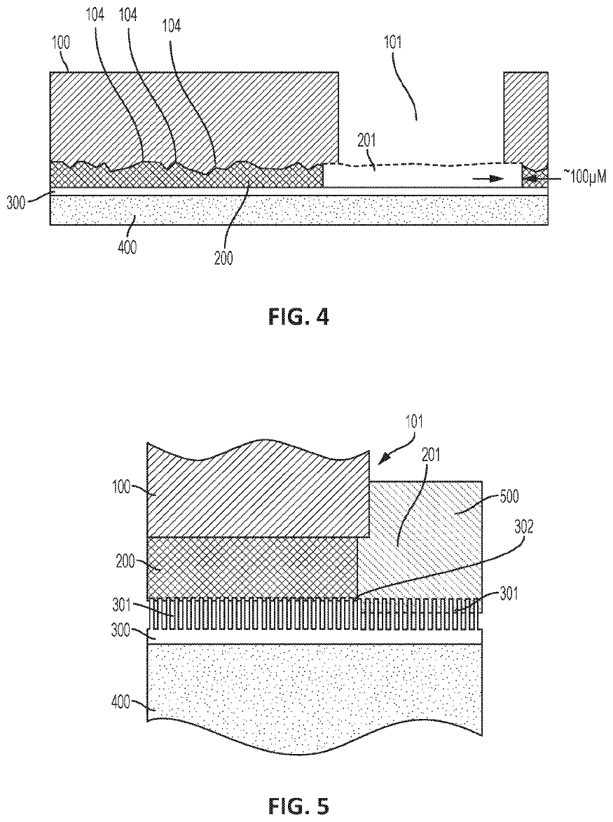

Third, and now referring to FIG. 4, malleable adhesive 200 further accommodates non-planar features on rigid body 100 that may be present due to machining, molding, or other means of fabricating rigid body 100 of device 10. Malleable adhesive 200 should have a thickness of approximately two times the anticipated runout of any surface features. For example, the anticipated runout may be 25, 50, 75, or 100 micrometers, and the thickness may be up to several hundred micrometers if needed to accommodate non-planar aspects 104 of the bottom of rigid body 100 arising from, for example, topography of the rigid body bottom after injection molding.

Fourth, and now referring to FIGS. 5, malleable adhesive 200 provides nanoscale blocking of the fluidic biological sample or any component thereof from migrating along the surface of planar substrate 400, including within (i.e., under the surface of) nanoporous layer 300 on planar substrate 400. Such migration would allow for the sample in a well to contaminate an adjacent well. Malleable adhesive 200 engages the surface of nanoporous layer 300 on planar substrate 400. In certain embodiments, nanoporous layer 300 is between 100 nm and 5000 nm thick. Nanoporous layer 300 has primary pores from the layer surface extending from tens to hundreds of nanometers into the layer. These pores can have interconnecting subsurface pores. If these subsurface pores are close to the surface, they can be an efficient diffusion pathway for a fluidic material, e.g., a component of the fluidic biological sample 500, to migrate away from one well (defined by the lack of malleable adhesive in the perforations 201 thereof) to another adjacent well, thus cross-contaminating the two samples. Malleable adhesive 200 contacts the exposed openings and near-surface walls 301 of the pore structure, for example, at 302. Fluidic components of fluidic biological sample 500 that would otherwise migrate by capillary action along or pore diffusion just below the surface of nanoporous layer 300 are halted at edge 302 by the presence of malleable adhesive 200.

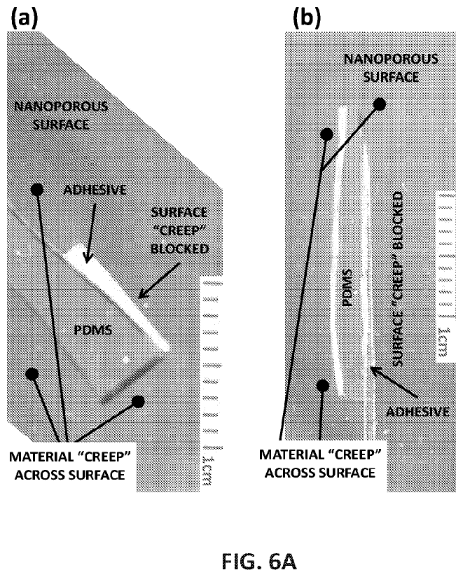

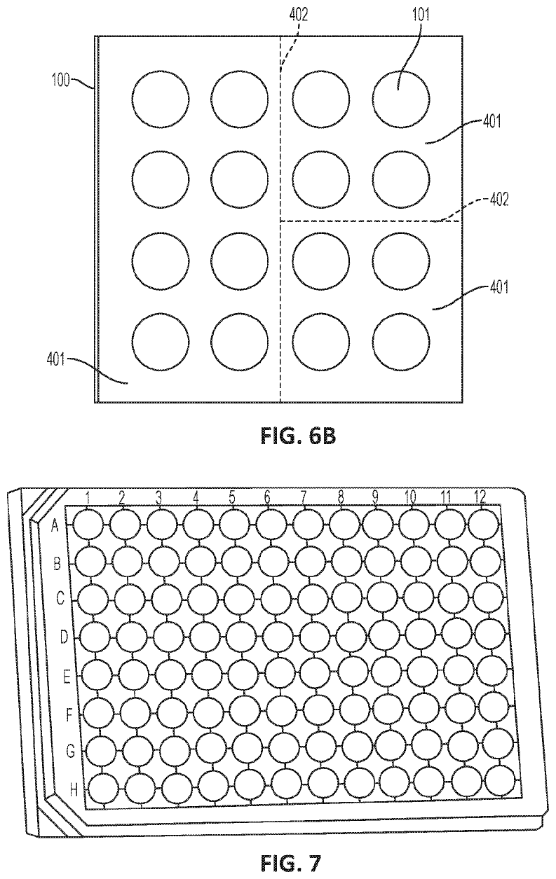

FIG. 6A(a) and 6A(b) show photographs of an exposed nanoporous layer on a planar substrate. In each photograph a Polydimethylsiloxane (PDMS, or “silicone”) material known to release polymeric molecular species is shown in the center of a planar substrate. The color change around the PDMS material indicates that the index of refraction of the nanoporous material is altered by the presence of the released species moving across and just under the surface of the nanoporous layer, including partially filling the pore structure (which is undesirable for the function of the present invention). A very thin strip of malleable adhesive is also shown adjacent to the silicone material at a particular location. In FIG. 6A(a), the color change indicating the movement of the contaminating species does not substantially exist past the malleable adhesive except for the ends of the malleable adhesive where the migration has proceeded around the end of the malleable adhesive, indicating that the migrating species are not able to move along and just below the surface in the presence of the malleable adhesive. The malleable adhesive in FIG. 6A(a) is about 1 mm in width. In FIG. 6A(b), a very thin strip of malleable adhesive was similarly affixed adjacent to a piece of the same PDMS. Again, the released species migrate away from the PDMS piece, including circling around the exposed end of the malleable adhesive piece. The wedge-shaped adhesive in this case varies in thickness from about 0.8 millimeters at the bottom of the photograph to only approximately 200 micrometers at the top. Examination of the thinner region shows that the released species were able to migrate under the malleable adhesive, demonstrating that sub-surface migration in the nanoporous layer is a contamination consideration. It should be noted, however, that the duration of this experiment was greater than 100 hours, while the bioanalytical processing that the present invention is intended to enable take about 1 hour, so the malleable adhesive is an effective barrier to both surface and sub-surface migration of the fluidic biological sample and components thereof.

The planar substrate 400 with a nanoporous layer 300 on it provides the essential function of the device as described elsewhere. In certain embodiments, planar substrate 400 comprises a material that is sufficiently planar (e.g. <50 micrometers non-planarity) and smooth (e.g. Rₐ<10 nm) so as to adhere to the rigid body by the use of a thin malleable adhesive. In particular embodiments, the material is rigid enough for handling during fabrication, i.e., out of plane bending, preferably less than 100 micrometers under gravity when handled by edges, such that the applied nanoporous layer does not crack, peel, flake, or otherwise become damaged. In some embodiments, the material is able to withstand 450 C for 10˜50 hours, a typical condition for the formation of a nanoporous layer. In certain embodiments, the material would have a thermal coefficient of expansion similar to amorphous silicon dioxide, the material of the nanoporous layer in some embodiments. In certain embodiments, the material would be transparent such that the integrity of the malleable adhesive seal can be visually inspected for trapped air bubbles and other defects or ultraviolet light can be used for setting certain types of malleable adhesives. The nanoporous layer comprises pores with the inter-pore walls of amorphous silicon dioxide fabricated by means known in the art. In summary, the starting point for the nanoporous layer is a liquid mixture of silicate and micelle-forming polymer. The nanoporous layer is formed by applying this liquid to the planar substrate by spin coating, spraying, printing, dip-coating, or other means known in the art. The film is cured at high temperature, including a temperature high enough and duration long enough to completely vaporize any residual polymeric material, which leaves behind nanopores in the layer. A plasma treatment of the surface further removes residual polymers.

In certain embodiments, the nanoporous layer is less than 1 micrometer thick and is closely contoured to the surface of the planar substrate. The pores on the surface of the nanoporous layer have a specific average diameter in the range of 2 nm up to 20 nm with the standard deviation of the diameter of the pores being less than the average diameter and the walls between the pores being between about 1 nm and 10 nm in thickness.

In certain embodiments, nanoporous layer 300 may have a uniform porosity that does not vary more than 10 or 5 percent across the surface of nanoporous layer 300. As used herein, the porosity is the ratio of the total pore volume to the overall dimensional volume, for example as measured by a spectroscopic ellipsometer. In certain embodiments, the porosity may be 40 percent to 60 percent. In specific embodiments, the porosity of nanoporous layer 300 may be approximately 55 percent, 63±5%, or up to 80%.

In certain embodiments, nanoporous layer 300 may include surface functionalization. In specific embodiments, the surface functionalization of nanoporous layer 300 may include making the surface more hydrophobic, e.g., by the addition of short chain hydrocarbons to the surface.

In certain embodiments, nanoporous layer 300 may be formed from silica precursors such that the pore wall material is silica. Other precursors can be used to create pore walls of other materials in different embodiments.

In certain embodiments nanoporous layer 300 may have thickness in the range of 100 nm to 5,000 nm.

Because maximizing the total surface area of the nanoporous layer in each well is an advantage in some uses of the device, and because the nanoporous layer conforms to the planar substrate, and because of the novel sealing attributes obtained by the use of a malleable adhesive, the surface of the planar substrate can be textured by means known in the art to increase the surface area.

For example, and without limitation, the surface of the planar substrate can comprise micro rulings, roughening, chemical or mechanical texturing, topography patterned into the surface by etching or other means, topography comprising chemically and thermally suitable materials upon the surface, or other structuring formed by means known in the art at a scale larger than about 1 micron.

Because the nanoporous layer conforms tightly to the planar substrate, it will further conform to structures on the surface of the planar substrate that effectively add surface area to the nanoporous layer. In certain embodiments, the application of a nanoporous layer less than about 1 micrometer thick to the following exemplary structures can results in a nanoporous layer having a surface area much larger than the equivalent planar area of the planar substrate.

For example, and without limitation, the surface of the planar substrate can comprise a fibrous structure with a nominal fiber diameter less than about 10 micrometers and nominal inter-fiber distances of less than about 10 micrometers, the fibers comprising glass, quartz or other chemically inert and thermally and mechanically stable materials. The nanoporous layer surface area additionally comprises the surface area of the fibrous structure. For example, and without limitation, the surface and subsurface of the planar substrate can comprise a thermally and mechanically stable porous material with a high effective surface area comprising a highly interconnected internal porous structure. The nanoporous layer surface area additionally comprises the surface area of the internal porous structure. For example, and without limitation, the surface can comprise a chemically, thermally, mechanically, or otherwise unstable material of high effective surface area, that is removed during the same thermal and chemical processing steps that remove the pore-forming polymeric components that lead to the nanopore structure of the nanoporous layer, so that a highly interconnected porous structural shell remains. The nanoporous layer surface area additionally comprises the surface area of the porous structural shell.

There is further utility in the development of analytical methods that use the present invention if a single device is able to present individual or groups of wells with different, unique combinations of parameters and attributes in the nanoporous layer. Such a configuration can allow multiple optimization experiments to occur on the one device in parallel. Referring to FIG. 6B, a certain embodiment comprises a single rigid body 100 coupled to a plurality of planar substrates 401 using a malleable adhesive (not shown). The parameters and attributes, individually or in combinations, of the nanoporous layer on each planar substrate may be different. The edges of the planar substrates 401 are dimensioned and aligned such that the seams 402 between the multiple planar substrates occur in the regions between the bottoms of the wells 101 on the rigid body 100, thus preventing leaking of fluid from the bottoms of the wells during use. Each well in the rigid body will have a sufficient portion of at most one of the planar substrates comprising a fully formed well bottom.

In a configuration known in the art, a thin (1 mm) flexible, perforated silicone sheet is laid on a planar substrate with a nanoporous layer, such that the perforations in the silicone sheet act like wells with a nanoporous layer at the bottom. In this configuration, the silicone sheet is not glued or otherwise adhered to the substrate. The silicone sheet is subject to shifting (thus repositioning the wells) and/or inadvertent pressures, tensions, or stresses, which could buckle the silicone sheet, in either case allowing fluidic sample material to move from one well to the next, spoiling such cross-contaminated samples. Further, the silicone material is impregnated with plasticizers that leach out in a very short time and migrate from the silicone sheet to fill near-by pores in the nanoporous layer (see FIG. 6). Finally, the silicone sheet is not at all rigid and offers no protection to the fragile substrate and the nanoporous layer upon it. In fact, the substrate provides all the mechanical stability and, therefore, accommodates the stresses associated with use. Embodiments of the present invention overcome these deficiencies through the novel coupling (including, for example, direct attachment) of the planar substrate with nanoporous layer to the bottom of a rigid body using a malleable adhesive, such that the portion of the nanoporous layer corresponding to a particular well is fixed; no contamination is introduced onto the nanoporous layer or into the fluidic biological sample; and the fragile planar substrate with nanoporous layer is fully protected by its attachment to and within the surrounding mechanical envelope of the rigid body.

In another configuration known in the art, solid phase extraction (“SPE”) plates (see FIG. 10) are 96-well, plate-like devices comprising 96 individual tubes of particulate material for the purpose of capturing and subsequently releasing species in a fluidic biological sample. In this configuration, the device operates only in a flow-through manner; the wells have no bottom of any kind. The fluidic sample travels through the particulate material and certain species may or may not be ultimately captured onto a particle, with the bulk of the fluidic sample draining out the bottom of the tube into a tray for disposal. Subsequently an empty 96-well tray is placed until the tubes and additional reagents made to flow through to potentially release certain species, which are captured as they drain into the second tray. Compared to embodiments of the present invention, the individual particles in this device interact with the fluidic sample only a short amount of time during the initial flow-through step and always when they are in hydrodynamic motion. In certain embodiments of the present invention, all species in the fluidic sample interact statically with the nanoporous layer at the bottom of each well with minimal kinetic disruption to the capturing process, and the capturing phase is controlled solely by the user of the device to any desired duration. Further, all operations with the present invention are performed solely within the device. No additional trays or apparatus, like vacuum manifolds and the application of pressure, are needed for basic operation in contrast to the SPE plate-like devices.

### EXAMPLES

### Example 1

### 96-Well Plate with Single Substrate of Uniform Wells

A certain embodiment of the present invention is obtained if the following restrictions are imposed on the device:
The rigid body is injection molded of polystyrene or polypropylene.
The rigid body comprises length, width, and height dimensions; features to support automated handling equipment; and a well layout in the form of an 8×12 array of circular 96 wells with a nominal bottom diameter of 6.5 mm, such dimensions, features, well layout, and wells conforming to industry standards published by ANSI/SLAS (https://slas.org/resources/information/industry-standards).
The planar substrate is 74×116 mm glass, 1.1 mm thick.
Nanoporous layer is applied to the glass substrate by dip-coating with a TEOS/L121/Ethanol co-polymer mixture and subsequent thermal and plasma treatments according to methods known in the art.
The planar substrate with nanoporous layer is attached to rigid body by a malleable adhesive sheet, e.g., 3M 4905, using distributed pressure in the range of 10 to 100 PSI.
   The malleable adhesive sheet has a hole pattern matching the 8×12 array of 96 wells in the rigid body with the adhesive hole diameter 100 μm larger than the rigid body well bottom opening.

### Example 2

### 96-Well Plate with Multiple Substrates of Uniform Wells

A preferred embodiment of the present invention is obtained if the following dimensional restrictions are imposed on the device:
The rigid body is injection molded of polystyrene or polypropylene.
The rigid body comprises length, width, and height dimensions; features to support automated handling equipment; and a well layout in the form of an 8×12 array of circular 96 wells with a nominal bottom diameter of 6.5 mm, such dimensions, features, well layout, and wells conforming to industry standards published by ANSI/SLAS (https://www.slas.org/resources/information/industry-standards).
The plurality of planar substrates comprises 4 glass pieces, each 37×58 mm glass, 1.1 mm thick.
   Generally, the planar substrates are glass pieces that each cover a subset of the rigid body wells, such that the edges of the planar substrates meet at the midline between rows and/or columns of wells (see FIG. 6B).
The nanoporous layer is applied to each glass substrate by dip-coating with a co-polymer mixture and subsequent thermal and plasma treatments according to methods known in the art, where each substrates receives a nanoporous material coating and/or treatment differing from the others in at least one parameter, e.g., pore size, surface charge, hydrophobicity.
The planar substrates with their nanoporous layers are attached to the rigid body by a malleable adhesive sheet, e.g., 3M 4905, using distributed pressure in a range up to 10 PSI.
   The malleable adhesive sheet has a hole pattern matching the 8×12 array of 96 wells in the rigid body with the adhesive hole diameter 100 μm larger than the rigid body well bottom opening.
   If all the wells of the rigid body are covered by a glass sheet, a single malleable adhesive layer can be used with the multiple glass sheets appropriately positioned prior to finalizing the bonding process.

### Example 3

### Methods of Use: Background and Size Exclusion and Electrostatic Interaction

Background

Amino acids, organic compounds that contain both a carboxyl (—COOH) and an amino (—NH2) group, are the building blocks of peptides and proteins. There are currently 22 amino acids commonly accepted by the scientific community, each with its own unique structure and physiochemical properties. Of the 22 amino acids, 20 are genetically encoded across all species and 2 are rare and are only produced under specific conditions. The 20 standard amino acids are put into one of three catalogers: 8 Non-polar (hydrophobic); 7 polar amino acids (noncharged but hydrophilic; 3 positively charged; and 2 negatively charged. Peptides are complex molecules that are made up multiple amino acids linked together in a specific order that is genetically encoded. Proteins are made up of multiple peptides linked together, increasing the complexity, size, and biological utility of the molecule.

Peptides characteristics are dependent on both the combination and order of the amino acids. A single peptide can have a highly hydrophobic region on one end and a highly hydrophilic region or charged region on the other end. Due to this complexity, peptides interactions can be multi-facetted.

Quantitation of peptides, endogenous (biomarkers) and exogenous (drug product), is required to confirm safety, tolerability, therapeutic indexes of drug products, activity and efficacy during drug development. The gold standard assay used for quantitation of proteins is enzyme-linked immunosorbent assay, or ELISA. ELISA is type of ligand-binding assay that where the molecule of interest (antigen) is immobilized on a solid surface, typically a 96-well plate, and then is interacted with an antibody specific for the antigen. This antibody an enzyme linked to it so that when its substrate is introduced to the well and incubated for a set amount of time, a measurable product is produced which can be directly correlated back to the concentration of the peptide of interest. This type of assay is very specific for proteins and is well established in the scientific community. However, reagents can be expensive, difficult to produce, take 3-6 months to produce a single batch and can have high batch to batch variability since the antibodies are usually produced in an animal model. ELISA also have some limitations when it comes to peptides. For example, Peptide X and Peptide Y may only differ by a single amino acid but have different functionalities within the body. However, the capture reagent can sometimes have difficulty discerning between a single amino acid difference.

A method used to overcome this lack of specificity for peptides is through the use of mass spectrometry (MS). Mass spectrometry is a very powerful analytical technique and can differentiate molecules down to less than a single atomic mass unit (or amu). Scientists have used various types of MS, such as MALDI HRMS, or LC-MS/MS, to identify and quantitate peptides and proteins in many different types of matrices, especially biological matrices such as blood, serum, urine or plasma during drug development. Although mass spectrometry can provide higher specificity, it typically requires sample clean up to remove interferences, unlike a ligand-binding assay (ELISA, etc.). Current methods for sample clean up (such as SPE) were developed for small molecule analysis and therefore are difficult to adapt to current large molecule drug programs. However, the present device was invented for these types of analyses as a critical tool for drug development as well as other areas of research in the life sciences.

Methods of Using Embodiments of the Present Invention

Embodiments of the present invention include a 96-well plate configuration for the separation and enhancement of peptides in wide variety of matrices from cerebral spinal fluid to plasma and serum. Certain embodiments of the present invention include a nanoporous layer comprising silicon dioxide with nanopores approximately 4 nm in size. The nanopores within the thin layer are negatively charged due to exposed silanol groups.

Two significant parameters have been identified that impact peptide recovery when using the device of the present invention: the size of the peptide or protein in relation to the average pore size of the nanoporous layer; and complimentary electrostatic interaction between the nanoporous layer surface and peptides of interest.

The first of these parameters is relatively straightforward; the pore size must be able to accommodate the volume of the target analyte of interest. The second parameter is more complex since peptides, according to their amino acid sequence, can feature both acidic and basic regions (zwitterionic peptides), so peptidomic responses to pH adjustments are difficult to predict and are often peptide dependent. TABLE 2 below provides general guidance on recommended pH adjustments to a peptide sample solution for peptides with various isoelectric points (pI). For example, if a peptide of interest features a pI of 5, it is recommended that the pH be adjusted to 3˜4 to improve peptide recovery on the device of the present invention (green regions).

To confirm that a peptide's interaction with the nanoporous layer of the present invention can be manipulated through the alteration of the sample's pH, a mixture of peptides and proteins ranging in size, pI, and hydrophobicity/hydrophilicity was prepared in non-biological matrix (see TABLE 1).

TABLE 1
Peptide mixture.

| | | | | | Amount | | | |
|---|---|---|---|---|---|---|---|---|
| | | | | | ( [symbol] /ul) | starting pH = 1.5 | | |
| | | | | | final volume | Used NaOH | Added | |
| Peptide | | MW | PI | | 200 uL | 1M | Volume | pH |
| 7 | [symbol] | 756 | 11.18 | Basic | 80 | | 2 uL | 5 |
| 8 | [symbol] | 3657 | 10.04 | bASIC | [symbol] | | 3 uL | 7.5-8 |
| 1 | [symbol] | 1046 | 7.95 | | 20 | | 5 uL | 11.5-12 |
| 2 | [symbol] | 1296 | 8.04 | | 20 | | | |
| 3 | [symbol] | 1570 | 3.47 | ACIDIC | 20 | | | |
| 4 | N Acetyl [symbol] | 1800 | 7.99 | BASIC | 20 | | | |
| 5 | ACTH [symbol] | 2095 | 10.96 | BASIC | 20 | | | |
| 6 | ACTH [symbol] | 2465 | 3.82 | ACIDIC | 20 | | | |
| 9 | [symbol] | 5808 | 5.24 | Neutral | [symbol] | | | |
| | [symbol] | 12351 | | | 15000 | | | |
| | [symbol] | 16952 | | | 12000 | | | |
| | [symbol] | 65430 | | | 50000 | | | |

[symbol]

indicates data missing or illegible when filed

The mix consists of molecules ranged in size from approximately 750 Dalton to 66,000 Dalton and from acidic to basic (negatively to positively charged). It is hypothesized that by altering the pH of the sample prior to loading it into the present invention system, the net charge of the peptides and proteins will change. As the pH gets lower than a whole pH unit below the pI of the molecule, the net charge of the peptide becomes closer to neutral or positive increasing the molecules ability to interact with the surface of the present invention. Additionally, it is expected that the larger proteins will not be able to enter the nanoporous layer pores and therefore will not be retained on the device.

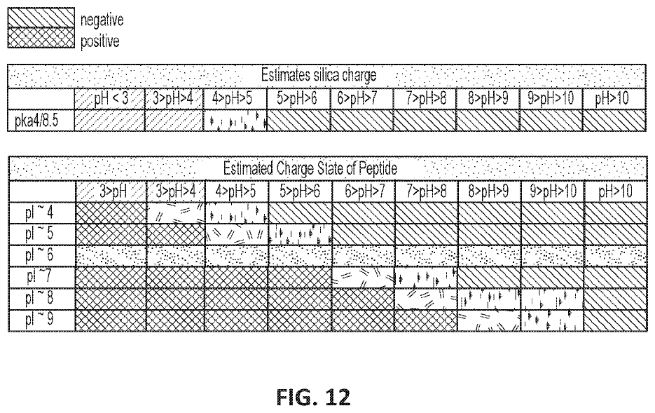

For the experiment, equal aliquots of the peptide mixture in neat solution were taken and adjusted (titrated) to different pHs ranging from 1.5 to 12. Before analysis, the relative retention of each peptide on the device of the present invention was predicted based on its size and its individual pI (see FIG. 12). These predicted present invention retentions were divided into three categories: detected, trace, and not detected.

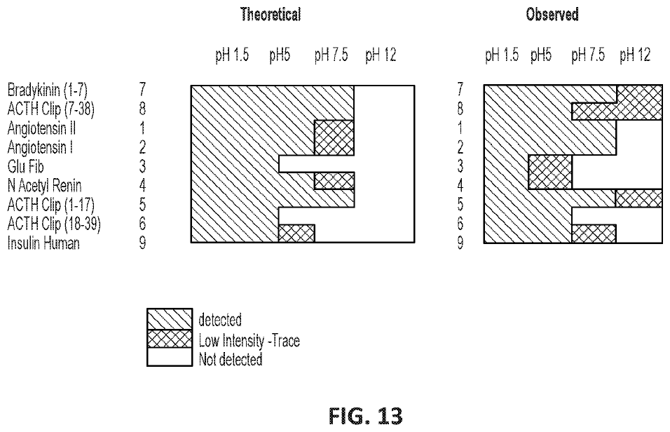

Each pH adjusted sample was analyzed via mass spectrometry and the observed peptide measurements were also plotted using the same categorization. The observed responses, as predicted by the individual peptide's pI and size, matched the theoretically predicted responses in most scenarios as shown in FIG. 13.

A total of 36 scenarios were tested and the following results were observed:
24/36 matched
8/36 were over predicted
4/36 were under predicted

These results confirm that beyond size exclusion via the pores of the nanoporous material, one of the controlling forces for the interaction of peptides with the nanoporous layer of the device of the present invention is electrostatic in nature.

### Example 4

### Methods of Use with Insulin B-Chain

The following describes a method of using the present invention to prepare a sample for mass spectrometer analysis. The method measures the amount of Insulin B Chain in a surrogate matrix (phosphate buffered saline containing albumin).

I. List of Reagents, Supplies, and Equipment
1. The device of the present invention in the embodiment comprising 96 identical wells
2. Pipettors and tips for micro volume handling
3. ParaFilm or round hole 96-well plate cover
4. Repeating pipettor and tips (Optional, but recommended)
5. Vacuum aspiration system (Optional, but recommended)
6. Phosphoric acid (PA)
7. Acetonitrile (ACN)
8. Formic acid (FA)
9. Trifluoroacetic acid (TFA)
10. Bovine serum albumin (BSA)
11. Phosphate-buffered saline (PBS)
12. Insulin B Chain (IBC)
13. Water (Recommended HPLC grade or Ultra purified (i.e. Millipore™) water
14. Multi-tube Shaker Table, Orbital Shaker or 96-well plate Vortexer (i.e. VWR™)
15. Glass vials with Teflon-lined caps (For ACN, FA and TFA reagents)
16. Gloves (Recommended: Wear gloves at all times when handling samples, plates, etc.)

II. Processing Procedure
1. Solution Preparation:
   1.1. Prepare sample solution as follows: 1 vol % PA+5 vol % ACN+94 vol % Sample
   NOTE: “Sample”: (3.0 vol % BSA in PBS+50 ng/ml IBC)
   The concentration of IBC may be varied depending on experimental design
   1.2. Prepare washing solution as follows: 1 vol % TFA in HPLC grade water
   1.3. Prepare elution solution as follows: 70 vol % ACN+5 vol % FA in HPLC grade water
2. Loading and Incubating the NanoFuge Device:
   2.1. Add 50 μl of Sample Solution (Section 2.1) to each well.
   2.2. Place ParaFilm® or other sealed well covering to prevent evaporation during incubation.
   2.3. Incubate for 30 minutes at room temperature on a slow moving shaker/rotation table.
   NOTE: Shaker/rotating table should provide gentle to mild agitation of the sample during incubation. Motion should not disturb sample enough elicit splashing of well contents.
3. Washing Steps:
   NOTES:
   Avoid contact between vacuum aspirator tip and well bottom surface.
   If using a robotic automated system, the user may need to adjust sample/washing solution volumes for the Washing Step Procedures according to the liquid handler minimum volume capability. This will allow sufficient liquid volume in each well for subsequent steps.
   3.1. Use vacuum aspiration to remove the liquid from the sample wells.
   3.2. Add 45-50 μl of washing solution (Section 2.2). Avoid using excess washing solution during the washing steps that may result in well overflow.
   3.3. Use vacuum aspiration to remove the washing solution from each sample well.
   3.4. Repeat washing steps 4.2-4.3 four (4) additional times.
4. Eluting Low Molecular Weight Peptides/Proteins:
   4.1. Add 50 μl of the freshly prepared (Section 2.3) eluent solution to each sample well. Pipet up and down about 30 times over about 30 seconds.
   4.2. Withdraw the eluent and place the elution product into the pre-labeled tubes, or 96 well collection plate, etc.
   4.3. Place tubes on ice until all elution products have been collected.
   4.4. If not to be used immediately, store the elution products in a freezer storage box.
   4.5. Samples are now ready for subsequent analysis, such as liquid chromatography mass spectrometry or MALDI-TOF mass spectrometry.

III. Exemplary Results

Results obtained using the present invention to prepare samples by the method above for analysis by liquid chromatography mass spectrometry (LC-MS). The LC-MS operating mode and conditions, known in the art, are as follows:

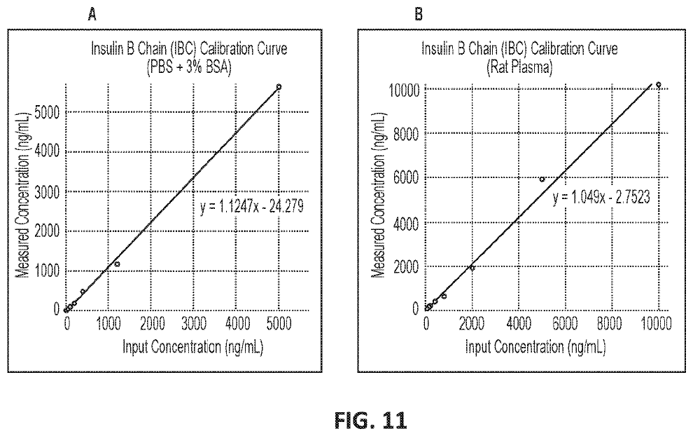

The response curve for a set of samples with linearly concentrations of IBC is shown in FIG. 11A in a surrogate matrix per the method above and FIG. 11B in rat serum, otherwise using the method above. Embodiments of the present invention are able to provide stable recovery rates across a wide range of target analyte concentrations.

Unlike liquid chromatography used in the competitive SPE plate prior art (as well as in HPLC, UPLC, and LCMS techniques), in embodiments of the present invention the fluidic biological sample does not pass through the device. It is not a flow-through device. There is no hydrodynamic force applied to the sample fluid by pressure or vacuum (as is used in the above techniques). In embodiments of the present invention, the fluidic sample is introduced into the wells of the device from the top and remains there statically while the molecules (including the target analyte(s)) diffuse toward and, if suitably compliant with the attributes of the nanoporous layer composing the bottom of the wells, diffusing into the nanopores for capture and subsequent extraction (after washing from the top). The captured target analytes are extracted by a subsequent addition of an elution buffer (from the top). In the prior art, the sample is introduced at the top of a column and flows through the device to exit at the bottom. During this flow, the target analyte(s) may be captured by the device for subsequent extraction (after washing by flow through).

Per Example 3 above, the inherent behavior of the device can be altered by the user to improve capture of target analytes if the fluidic biological sample is disposed within the well of the device in combination with reagents (known in the art) that adjust the sample to a specific pH level such that the target analyte enters a positive charge state.

### REFERENCES

The following references are incorporated herein by reference:

U.S. Pat. No. 8,685,755

U.S. Pat. No. 8,753,897

U.S. Patent Publication 2014/0342466

Ji, Q. C., Gage, E. M., Rodila, R., Chang, M. S. and El-Shourbagy, T. A. (2003), Method development for the concentration determination of a protein in human plasma utilizing 96-well solid-phase extraction and liquid chromatography/tandem mass spectrometric detection. Rapid Commun. Mass Spectrom., 17: 794-799. doi:10.1002/rcm.981.

1. A device for enriching a molecular component within a sample, the device comprising:
a rigid planar substrate comprising a first side and a second side;
a malleable adhesive;
a nanoporous layer coupled to the first side of the rigid planar substrate, wherein the nanoporous layer is disposed between the rigid planar substrate and the malleable adhesive; and
a plurality of wells coupled to the nanoporous layer, wherein the malleable adhesive seals the plurality of wells to the nanoporous layer.

2. A device for enriching a molecular component within a sample, the device comprising:
a plurality of rigid planar substrates, each comprising a first side and a second side;
a malleable adhesive;
a plurality of nanoporous layers coupled to the first side of each rigid planar substrate, wherein the nanoporous layers are disposed without overlap between the rigid planar substrates and the malleable adhesive; and
a plurality of wells coupled to the nanoporous layers, wherein the malleable adhesive seals each of the plurality of wells to only one of the nanoporous layers.

3. The device of claim 2 wherein each of the plurality of nanoporous layers differs in at least one parameter.

4. The device of claim 3 wherein the at least one parameter is selected from the group consisting of thickness, porosity, pore size, pore wall material, surface functionalization, and surface interaction.

5. The device of claim 1 or 2 wherein the malleable adhesive layer comprises a plurality of perforations.

6. The device of claim 5 wherein the plurality of perforations correspond in size and shape to the plurality of wells.

7. The device of claim 5 wherein the plurality of perforations comprises circular perforations and the plurality of wells comprise circular wells.

8. The device of claim 7 wherein the plurality of perforations comprises circular perforations that are larger in diameter than the circular wells.

9. The device of claim 8 wherein the plurality of perforations comprises circular perforations that are larger in diameter than the circular wells by 50-150 micrometers.

10. The device of claim 8 wherein the plurality of perforations comprises circular perforations that are larger in diameter than the circular wells by 100 micrometers.

11. The device of claim 1 or 2 wherein the plurality of wells comprises walls extending through a rigid body.

12. The device of claim 1 or 2 wherein the nanoporous layer forms a bottom layer of the plurality of wells.

13. The device of claim 1 or 2 wherein a surface of the first side of the one or more planar substrates comprises a feature which increases a surface area of a nanoporous layer coupled thereto.

14. The device of claim 13 wherein the feature is selected from the group consisting of micrometer-scale rulings, roughening, chemical or mechanical texturing, topography patterned into the surface by etching, and additive microfibers.

15. The device of claim 1 wherein the nanoporous layer comprises a thickness that does not vary more than 10 percent across the nanoporous layer.

16. The device of claim 1 wherein the nanoporous layer comprises a thickness that does not vary more than 5 percent across the nanoporous layer.

17. The device of claim 1 wherein the nanoporous layer comprises a porosity that does not vary more than 10 percent across the nanoporous layer.

18. The device of claim 1 wherein the nanoporous layer comprises a porosity that does not vary more than 5 percent across the nanoporous layer.

19. The device of claims 1 and 2 wherein the average pore diameter is from 3 nm to 10 nm.

20. The device of claims 1 and 2 wherein the average pore diameter is less than 3 nm.

21. The device of claims 1 and 2 wherein the average pore diameter is more than 10 nm.

22. The device of claim device of claim 19 wherein the average pore diameter is between 3 and 4 nm.

23. The device of claim 19 wherein the average pore diameter is between 4 and 5 nm.

24. The device of claim 19 wherein the average pore diameter is between 5 and 6 nm.

25. The device of claim 19 wherein the average pore diameter is between 6 and 7 nm.

26. The device of claim 19 wherein the average pore diameter is between 7 and 8 nm.

27. The device of claim 19 wherein the average pore diameter is between 8 and 9 nm.

28. The device of claim 19 wherein the average pore diameter is between 9 and 10 nm.

29. A method of enriching a target analyte within a sample, the method comprising:
obtaining a device according to claim 1;
mixing the sample with one or more reagents to form a sample reagent mixture;
introducing the sample reagent mixture into one or more wells of the plurality of wells, wherein the target analyte is retained by the nanoporous layer at the bottom of each of the one or more wells and wherein a supernatant remains in each of the one or more wells;
removing the supernatant from each of the one or more wells;
adding a washer buffer to each of the one or more wells;
removing the washer buffer from each of the one or more wells;
adding an elution buffer to each of the one or more wells to release the target analyte from the nanoporous layer; and
removing the elution buffer and the target analyte from each of the one or more wells.

30. The method of claim 29 wherein the one or more reagents comprise a compound configured to adjust the pH of the sample reagent mixture to enhance an affinity of the target analyte to be retained by the nanoporous layer.

31. The method of claim 29 wherein the elution buffer comprises a compound configured to adjust the pH of the sample reagent mixture to reduce an affinity of the target analyte to be retained by the nanoporous layer.

32. A method of enriching a target analyte within a sample, the method comprising:
obtaining a device according to claim 2;
mixing the sample with one or more reagents to form a sample reagent mixture;
introducing the sample reagent mixture into one or more wells of the plurality of wells, wherein the target analyte is retained by the nanoporous layer at the bottom of each of the one or more wells and wherein a supernatant remains in each of the one or more wells;
removing the supernatant from each of the one or more wells;
adding a washer buffer to each of the one or more wells;
removing the washer buffer to each of the one or more wells;
adding an elution buffer to each of the one or more wells to release the target analyte from the nanoporous layer; and
removing the elution buffer and the target analyte from each of the one or more wells.

33. The method of claim 32 wherein the one or more reagents comprise a compound configured to adjust the pH of the sample reagent mixture to enhance an affinity of the target analyte to be retained by the nanoporous layer.

34. The method of claim 32 wherein the elution buffer comprises a compound configured to adjust the pH of the sample reagent mixture to reduce an affinity of the target analyte to be retained by the nanoporous layer.

35. A method of enriching a target analyte within a sample, the method comprising:
obtaining a device comprising:
at least one rigid planar substrate comprising a first side and a second side;
a malleable adhesive;
a plurality of nanoporous layers coupled to the first side of the at least one rigid planar substrate, wherein the nanoporous layers are disposed without overlap between the at least one rigid planar substrate and the malleable adhesive; and
a plurality of wells coupled to the nanoporous layers, wherein the malleable adhesive seals each of the plurality of wells to only one of the nanoporous layers;
mixing portions of the sample with each of a plurality of reagents to form a plurality of sample reagent mixtures;
introducing the plurality of sample reagent mixtures into the plurality of wells, wherein:
only one sample reagent mixture of the plurality of sample reagent mixtures is added to each well of the plurality of wells;
the target analyte is retained by the nanoporous layer at the bottom of each well of the plurality of wells; and
a supernatant remains in each well of the plurality of wells;
removing the supernatant from each well of the plurality of wells;
adding a washer buffer to each well of the plurality of wells;
removing the washer buffer from each well of the plurality of wells;
adding an elution buffer to the plurality of wells to release the target analyte from the plurality of nanoporous layers; and
removing the elution buffer and the target analyte from each well of the plurality of wells.

36. The method of claim 35 further comprising comparing an amount of target analyte removed from each well of the plurality of wells.

37. The method of claim 36 further comprising determining a maximum amount of the amount of target analyte removed from each well of the plurality of wells.

38. The method of claim 37 further comprising determining an optimal well from which the maximum amount of target analyte was removed.

39. The method of claim 38 further comprising:
documenting the nanoporous layer to which the optimal well is sealed; and
documenting the reagent that was mixed in the sample reagent mixture that was introduced in the optimal well.

40. The method of claim 35 wherein each of the plurality of nanoporous layers differs in at least one parameter.

41. The method of claim 35 wherein at least two of the plurality of nanoporous layers differ in thickness.

42. The method of claim 35 wherein at least two of the plurality of nanoporous layers differ in porosity.

43. The method of claim 35 wherein at least two of the plurality of nanoporous layers differ in pore size.

44. The method of claim 35 wherein at least two of the plurality of nanoporous layers differ in pore wall material.

45. The method of claim 35 wherein at least two of the plurality of nanoporous layers differ in surface functionalization.

46. The method of claim 35 wherein at least two of the plurality of nanoporous layers differ in surface interaction.
